(19) United States
(12) Patent Application Publication
(10) Pub. No.: US 2003/0082016 A1
(43) Pub. Date: May 1, 2003

(54) Blower with directional output nozzle

(76) Inventors: Jimmy N. Eavenson SR., Aurora, OH (US); William Kocka, Medina, OH (US); Amit Saha, North Ridgeville, OH (US)

Correspondence Address: EMERSON & SKERIOTIS, Fourteenth Floor, One Cascade Plaza, Akron, OH, 44308-1147, US

(21) Appl. No.: 10/261,985

(22) Filed: Sep. 30, 2002

Related U.S. Application Data
(60) Provisional application No. 60/325,892, filed on Sep. 28, 2001.

(51) Int. Cl. B65G 53/04

(52) U.S. Cl. 406/38

(57) ABSTRACT

An improved blower with a directional output nozzle is provided for various tasks such as moving debris or drying surfaces. The blower includes a frame mounted on wheels and a motor mounted to the frame. The blower also includes a housing with an inlet opening and directional output nozzle. An impeller is located in the blower housing and is driven by the motor to generate airflow. As the impeller rotates, air is drawn in through the inlet opening and is discharged through the output nozzle. The output nozzle can be repositioned by rotation by either local control or remote actuation.

This application claims priority to U.S. Ser. No. 60/325,892 entitled BLOWER WITH DIRECTIONAL OUTPUT NOZZLE, filed Sep. 28, 2001. This invention pertains to applications for moving debris and more specifically to a directional output nozzle to be mounted on a blower housing of a blower that allows rotation of the nozzle.

### I. BACKGROUND OF THE INVENTION

A. Field of Invention

This invention pertains to a blower for moving debris or drying surfaces, and more specifically, to a directional output nozzle to be mounted on a blower housing of a blower that allows for rotation of the discharge chute in order to vary the direction of the airflow.

B. Description of Related Art

Mobile blowers for moving leaves and other debris from lawns, driveways or other surfaces are known in the art. Generally, a blast of air is directed from a blower outlet toward or across the surface to be cleared. The blower outlet is usually adapted to be adjacent the ground so that the air blast exits from the bottom of the blower.

Currently available walk behind type blowers are generally one of three configurations: 1) fixed direction output, 2) bi-directional output using a diverting valve, and 3) variable-direction output using a means to rotate the blower nozzle.

For fixed direction blowers, the output from the blower is in one direction relative to the blower housing (shroud) and frame. The velocity profile within the outlet nozzle area is typically unknown and of no concern. In order to re-direct the airflow, the entire blower must be repositioned.

For bi-directional blowers, the output (all or a portion thereof) can be re-directed to a secondary orientation relative to the blower housing by the use of a valve or deflector. This valve or deflector provides a split of the airflow whereby 0% to 100% of the airflow can be redirected.

For variable directional blowers, the output can be redirected by repositioning the blower nozzle in relation to the shroud.

The above configurations require that many different support frames, blower housings, and impellers be made available to accommodate various output control means, shroud designs, and engine types. The designs also require that the user adjust the control means that has almost infinite settings and this can provide operator confusion, loss of productivity, and reduced blower efficiency.

### II. SUMMARY OF THE INVENTION

An improved blower with a directional output nozzle is provided for various tasks such as moving debris or drying surfaces. The blower includes a frame mounted on wheels and a motor mounted to the frame. The blower also includes a housing with an inlet opening and directional output nozzle. An impeller is located in the blower housing and is driven by the motor to generate airflow. As the impeller rotates, air is drawn in through the inlet opening and is discharged through the output nozzle. The output nozzle can be repositioned by rotation by either local control or remote actuation. The nozzle can also be arranged in various configurations such as diameter, length, shape, etc. to optimize air flow with respect to air volume, air velocity and head pressure to maximize performance for specific tasks such as leaf blowing, sidewalk clearing/cleaning, drying grass or pavement and inflating inflatable devices.

The present invention also accommodates a variety of attachments such as hoses, material injection devices, etc. for specific tasks. The present invention also allows for one size blower housing and impeller to be matched to smaller and larger power rated engines by varying the nozzle restriction. This allows for commonization of components such as the blower housing, support frame, impeller, etc.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of the first embodiment of the blower with the nozzle in the first position.

FIG. 2 is a perspective view of the first embodiment of the blower with the nozzle in the second position.

FIG. 3 is a side view of a second embodiment of the blower.

FIG. 4 is a side view of the blower housing, discharge chute, and nozzle of the second embodiment.

### IV. DESCRIPTION OF THE PREFERRED EMBODIMENT

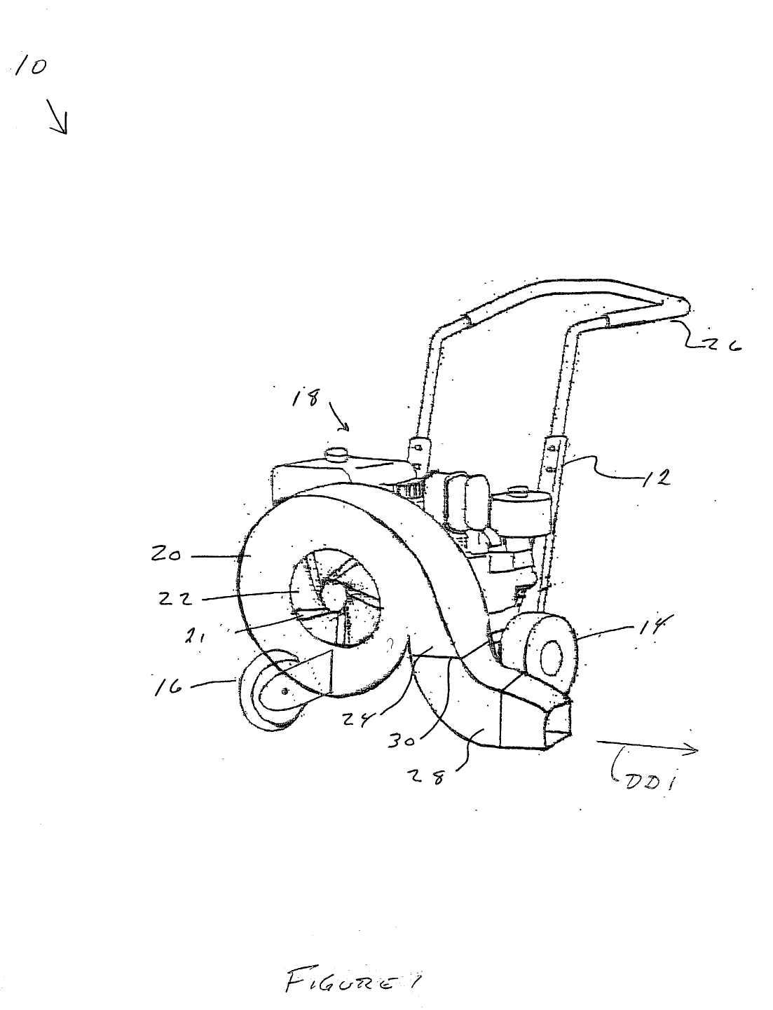

Referring now to the drawings wherein the showings are for purposes of illustrating a preferred embodiment of the invention only and not for purposes of limiting the same, FIG. 1 is directed to a centrifugal-type blower 10 having a frame 12 mounted on wheels 14 and 16. A motor 18 is mounted to frame 12. A blower housing 20 that houses an impeller 21 is mounted to frame 12. A handle 26 is also attached to the frame 12 and is adapted for an operator to push in order to move the blower 10 along a surface to be cleared, dried, etc.

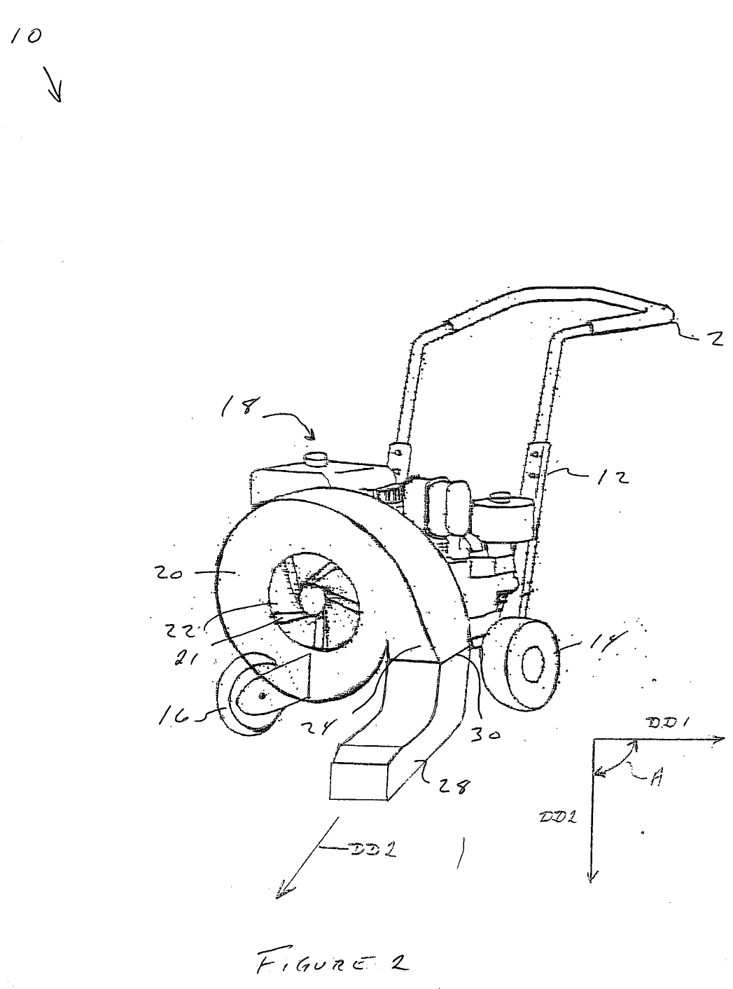

With reference to FIGS. 1 and 2, the blower housing 20 further consists of an air inlet 22, an outlet 24, and a nozzle 28. The nozzle 30 is connected to the outlet 24 in such a manner that allows the nozzle 28 to rotate about a horizontal axis 30 and between a first and second position with respect to the blower housing 20. It should be noted that the nozzle 28 can be connected to the outlet 24 by any mechanical means necessary chosen with sound engineering judgment. FIG. 1 shows the nozzle 28 in the first position and FIG. 2 shows the nozzle in the second position. When the nozzle 28 is in the first position the nozzle 28 has a first discharge direction denoted by the arrow labeled DD1 as illustrated in FIG. 1. In this position, the debris is being cleared to the side of the blower 10. When the nozzle 28 is in the second position the nozzle 28 has a second discharge direction denoted by the arrow labeled DD2. In this position, the debris is cleared to the front of the blower 10. The nozzle 28 can be positioned to clear debris at any position between the first DD1 and second DD2 discharge directions. The position between the first and second discharge directions is denoted as angle A as shown on FIG. 2. As the nozzle 28 is rotated through the angle A the nozzle 28 remains parallel to the ground thus angle A is on a plane parallel to the ground. In the first embodiment, the nozzle 28 can be rotated through an angle up to 90 degrees.

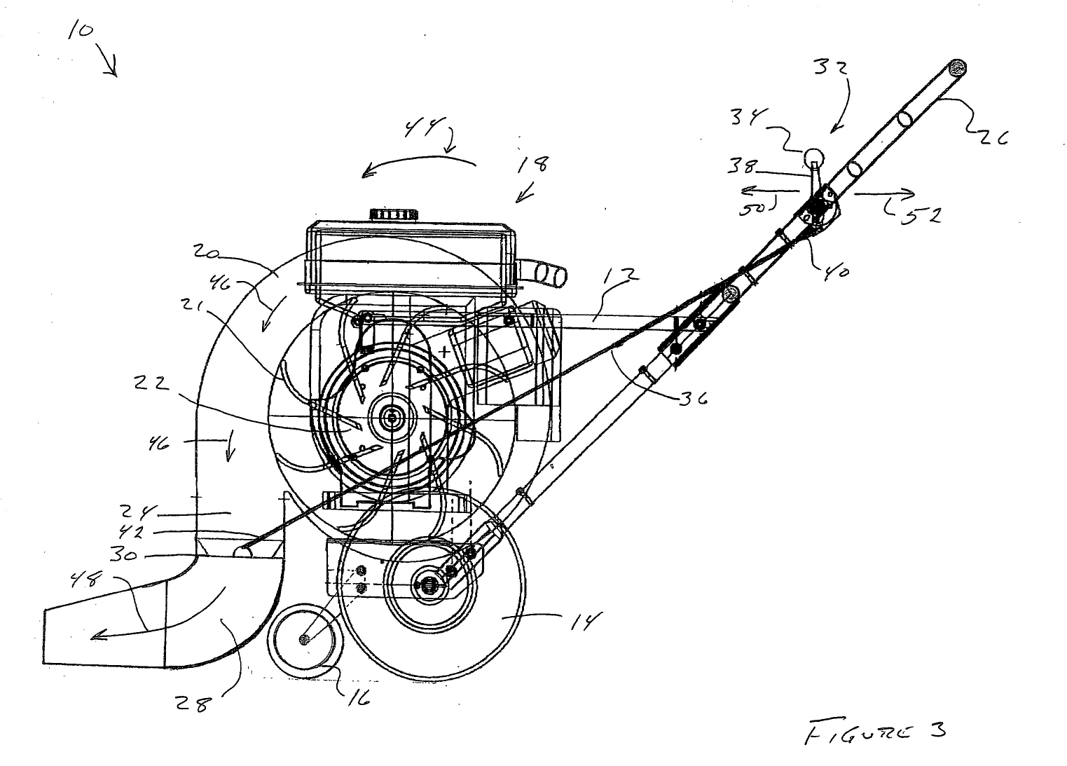

FIG. 3 shows a second embodiment of the present invention. In this embodiment, the nozzle 28 also rotates about a horizontal axis 30. However, in this embodiment the nozzle 28 has the capability of rotating 90 degrees in a direction to the operator's left or to the operator's right. For the purpose of illustration, the operator is assumed to be standing behind the blower 10 and grasping the handle 26 as one would during normal operation. When the nozzle 28 is rotated 90 degrees to the operator's left the nozzle is in the first position (not shown) and has a first discharge direction. Conversely, when the nozzle 28 is rotated 90 degrees to the operator's right the nozzle 28 is in a second position (not shown) and has a second discharge direction. As in the first embodiment, the angle between the nozzle 28 in the first position and the nozzle 28 in the second position is referred to as angle A (not shown). As the nozzle 28 is rotated through the angle A the nozzle 28 remains parallel to the ground thus angle A is on a plane parallel to the ground. In the second embodiment, the nozzle 28 can be rotated to clear debris through an angle up to 180 degrees. It should be noted that the nozzle 28 can be positioned at infinite positions between and including the first and second positions. In addition, the nozzle 28 can also be positioned at discrete predetermined positions between and including the first and second positions.

With continued reference to FIG. 3, in the preferred embodiment, the blower 10 further consists of a mechanical positioning means 32 to position the direction of the nozzle 28. The positioning means 32 further consists of a control device 34 and a control rod 36. In the preferred embodiment, the control device 34 consists of a lever 38. It should be noted that the lever 38 can be located on the nozzle 28 or may be located at remote location such as mounted to the handle 26 as shown in FIG. 3. It should be further noted that control device 34 can be any device commonly known in the art chosen with sound engineering judgment such as a handle or the like. The control rod 36 further consists of a first 40 and second 42 end. The first end 40 of the control rod 36 is connected the control device 34 and the second end 42 of the control rod 36 is connected to the nozzle 28 near the horizontal axis 30. The control rod 26 can be connected to the control device 34 and to the nozzle 28 by any mechanical means necessary chosen with sound engineering judgment. It should be noted that the positioning means 34 can also consist of an electromechanical device (not shown), an electro-hydraulic device (not shown) or an electro-pneumatic device (not shown). These devices may include a control device 34 such as a button, switch, lever, or the like that when activated energize a solenoid valve that would open or close an electrical circuit thereby actuating a means to rotate the nozzle 28. This means may include mechanical gears, hydraulic cylinders, or pneumatic cylinders.

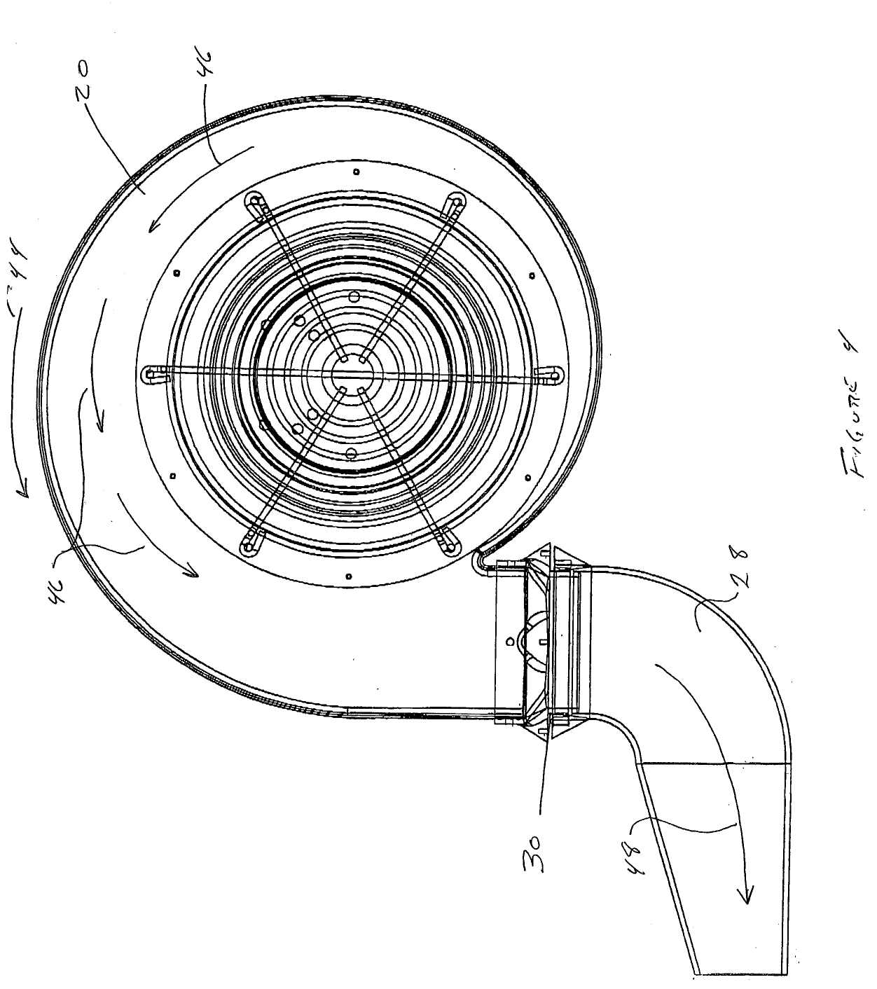

With the components of the present invention herein described, the operation of the blower 10 will now be described. For the purposes of illustration reference numbers from FIG. 3 will be used to describe the operation of the present invention. Referring to FIG. 3, the operator starts the motor 18 by methods commonly known in the art. The motor 18 in turn drives the impeller 21 in a direction as indicated by the arrow 44. As the impeller 21 rotates, air is drawn through the air inlet 22 and around the blower housing 20 in a direction indicated by the arrows 46. The airflow travels through the blower housing 20, through the outlet 24 and exits through the nozzle 28 indicated by the arrow 48. The direction of airflow can best be seen in FIG. 4. In order to change the direction of the nozzle 28 the operator grasps the lever 38 and moves it in a forward direction indicated by the arrow 50. The lever 38 in turn pulls the control rod 36 and the second end 42 of the control rod 36 rotates the nozzle 28 in a direction toward the first position. To rotate the nozzle toward the second direction the operator then grasps the lever 38 and moves in a backward direction indicated by the arrow 52. The lever 38 in turn pushes the control rod 36 and the second end 42 of the control rod 36 rotates the nozzle toward the second position.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invetion, it is now claimed:

What is claimed:

1. A blower unit comprising:
a frame;
at least a first ground engaging wheel supported by the frame;
a motor mounted to the frame;
a blower housing mounted to the frame, the blower housing having an outlet;
an impeller located within the blower housing, the impeller being selectively driven by the motor; and,
a nozzle operatively communicating with the outlet of the blower housing, the nozzle being selectively positional between a first position where the nozzle has a first discharge direction DD1 and a second position where the nozzle has a second discharge direction DD2, the first discharge direction DD1 and the second discharge direction DD2 being separated by an angle A that is at least 10°.

2. The blower unit of claim 1 further comprising:
positioning means for positioning the nozzle in the first and second positions.

3. The blower unit of claim 2 wherein the positioning means comprises:
a control device that is located remote from the nozzle.

4. The blower unit of claim 3 wherein the positioning means is mechanical.

5. The blower unit of claim 3 wherein the positioning means is electromechanical.

6. The blower unit of claim 3 wherein the positioning means is electro-hydraulic.

7. The blower unit of claim 3 wherein the nozzle is juxtaposed to the ground and angle A is on a plane substantially parallel with the ground.

8. The blower unit of claim 3 wherein the nozzle can be selectively infinitely positioned at any point between and including the first and second positions.

9. The blower unit of claim 3 wherein the nozzle can be selectively positioned at a plurality of discrete predetermined points including the first and second positions.

10. The blower unit of claim 1 wherein the angle A is at least 45°.

11. A blower unit comprising:
a frame;
a handle operatively attached to the frame;
at least a first ground engaging wheel supported by the frame;
a motor mounted to the frame;
a blower housing mounted to the frame, the blower housing having an outlet;
an impeller located within the blower housing, the impeller being selectively driven by the motor;
a nozzle operatively communicating with the outlet of the blower housing, the nozzle being selectively positional between a first position where the nozzle has a first discharge direction DD1 and a second position where the nozzle has a second discharge direction DD2, the first discharge direction DD1 and the second discharge direction DD2 being separated by an angle A that is at least 45°; and,
positioning means for positioning the nozzle in the first and second positions, the positioning means including a control device that is located on the handle.

12. The blower unit of claim 1 wherein the nozzle is juxtaposed to the ground and angle A is on a plane substantially parallel with the ground.

13. The blower unit of claim 12 wherein the nozzle can be selectively infinitely positioned at any point between and including the first and second positions.

14. The blower unit of claim 12 wherein the nozzle can be selectively positioned at a plurality of discrete predetermined points including the first and second positions.

15. A method for changing the position of a nozzle comprising the steps of:
providing a blower unit comprising, a frame, at least a first ground engaging wheel supported by the frame, a motor mounted to the frame, a blower housing having an outlet and being mounted to the frame, an impeller selectively driven by the motor and located within the blower housing, and a nozzle operatively communicating with the outlet of the blower housing; and,
repositioning the nozzle from a first position where the nozzle has a first discharge direction DD1 to a second position where the nozzle has a second discharge direction DD2, the first discharge direction DD1 and the second discharge direction DD2 being separated by an angle A that is at least 10°.

16. The method of claim 15 further comprising the steps of:
providing positioning means for positioning the nozzle in the first and second positions
wherein the step of repositioning the nozzle from a first position to a second position comprises the step of:
activating the positioning means.

17. The method of claim 16 further comprising the steps of:
providing a control device that is located remote from the nozzle;
wherein prior to the step of activating the positioning means, the method comprises the step of:
adjusting the control device.
